(19) United States
(12) Patent Application Publication
(10) Pub. No.: US 2026/0313620 A1
(43) Pub. Date: Oct. 8, 2026

(54) REQUESTS FOR COMPUTATIONAL RESOURCE ALLOCATION

(71) Applicant: QUALCOMM Incorporated, San Diego, CA (US)

(72) Inventors: Hua WANG, Basking Ridge, NJ (US); Qing LI, Princeton Junction, NJ (US); Sony AKKARAKARAN, Poway, CA (US); Navid ABEDINI, Basking Ridge, NJ (US); Narayan PRASAD, Westfield, NJ (US); Tao LUO, San Diego, CA (US); Junyi LI, Greentown, PA (US)

(21) Appl. No.: 19/542,098

(22) Filed: Feb. 17, 2026

Related U.S. Application Data
(60) Provisional application No. 63/782,311, filed on Apr. 2, 2025.

(51) Int. Cl. H04W 72/0446; H04W 74/0833; H04W 76/20

(52) U.S. Cl. CPC H04W 72/0446; H04W 74/0833; H04W 76/20

(57) ABSTRACT

Various aspects of the present disclosure generally relate to wireless communication. In some aspects, a user equipment (UE) may send, to a network device, a compute request that requests additional computing resources from a serving device for performing a computational task. The UE may receive, from the network device, a response to the compute request indicating an availability of the additional computing resources. In some aspects, the additional computing resources may be external to the UE and may not be currently allocated to or available to the UE. Numerous other aspects are described.

### CROSS-REFERENCE TO RELATED APPLICATION

This Patent Application claims priority to U.S. Provisional Patent Application No. 63/782,311, filed on Apr. 2, 2025, entitled “REQUESTS FOR COMPUTATIONAL RESOURCE ALLOCATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with requests for computational resource allocation.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In a wireless network, cooperative or distributed computing may enable computational tasks to be shared among multiple devices within the network. Such an approach may leverage computational power from various devices, such as smartphones, tablets, and smartwatches, to perform computational operations.

### SUMMARY

In a wireless network, cooperative or distributed computing may enable computational tasks to be shared among multiple devices within the network. The mechanisms for a UE to request computational resources from the network or other devices are associated with higher-layer signaling, which can result in significant delays and limit the control that a radio access network (RAN) might have over the process of implementing cooperative or distributed computing across devices. Additionally, the mechanisms for a UE to request computational resources from the network may lack a clear protocol by which the network may communicate the acceptance or rejection of the computational requests to the UE. Such a lack of clarity may lead to uncertainty and inefficiency in a process of enabling cooperative or distributive computing.

Accordingly, some aspects described herein relate to enabling a UE to utilize idle computing resources from other devices, by enabling communications between the UE and a network device concerning the UE's request for additional computing resources. Some aspects more specifically relate to the UE sending a compute request to the network device, requesting additional computing resources from a serving device for performing a computational task, and subsequently receiving a response from the network device indicating an availability of the additional computing resources. In some aspects, the additional computing resources may be external to the UE and may not be currently allocated to or available to the UE.

Some aspects described herein relate to a user equipment (UE). The UE may include a processing system. The processing system may include one or more processors and one or more code-storing memories coupled with the one or more processors. The processing system may be configured to cause the UE to send, to a network device, a compute request that requests additional computing resources from a serving device for performing a computational task. The processing system may be configured to cause the UE to receive, from the network device, a response to the compute request indicating an availability of the additional computing resources.

Some aspects described herein relate to a network device. The network device may include a processing system. The processing system may include one or more processors and one or more code-storing memories coupled with the one or more processors. The processing system may be configured to cause the network device to receive, from a UE, a compute request that requests additional computing resources from a serving device for performing a computational task. The processing system may be configured to cause the network device to send, to the UE, a response to the compute request indicating an availability of the additional computing resources.

Some aspects described herein relate to a method of wireless communication performed by a UE. The method may include sending, to a network device, a compute request that requests additional computing resources from a serving device for performing a computational task. The method may include receiving, from the network device, a response to the compute request indicating an availability of the additional computing resources.

Some aspects described herein relate to a method of wireless communication performed by a network device. The method may include receiving, from a UE, a compute request that requests additional computing resources from a serving device for performing a computational task. The method may include sending, to the UE, a response to the compute request indicating an availability of the additional computing resources.

Some aspects described herein relate to a non-transitory computer-readable medium that stores a set of instructions for wireless communication by a UE. The set of instructions, when executed by one or more processors of the UE, may cause the UE to send, to a network device, a compute request that requests additional computing resources from a serving device for performing a computational task. The set of instructions, when executed by one or more processors of the UE, may cause the UE to receive, from the network device, a response to the compute request indicating an availability of the additional computing resources.

Some aspects described herein relate to a non-transitory computer-readable medium that stores a set of instructions for wireless communication by a network device. The set of instructions, when executed by one or more processors of the network device, may cause the network device to receive, from a UE, a compute request that requests additional computing resources from a serving device for performing a computational task. The set of instructions, when executed by one or more processors of the network device, may cause the network device to send, to the UE, a response to the compute request indicating an availability of the additional computing resources.

Some aspects described herein relate to an apparatus for wireless communication. The apparatus may include means for sending, to a network device, a compute request that requests additional computing resources from a serving device for performing a computational task. The apparatus may include means for receiving, from the network device, a response to the compute request indicating an availability of the additional computing resources.

Some aspects described herein relate to an apparatus for wireless communication. The apparatus may include means for receiving, from a UE, a compute request that requests additional computing resources from a serving device for performing a computational task. The apparatus may include means for sending, to the UE, a response to the compute request indicating an availability of the additional computing resources.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram of an example of a core network configured to provide network slicing.

FIG. 3 is a diagram illustrating an example disaggregated network node architecture.

FIG. 4 is a diagram illustrating an example of a two-step random access procedure.

FIG. 5 is a diagram illustrating an example of a four-step random access procedure.

FIG. 6 is a diagram illustrating an example of device cooperation for distributed or cooperative computing.

FIGS. 7A-7D are diagrams illustrating examples associated with requests for computational resource allocation.

FIG. 8 is a diagram illustrating an example process performed, for example, at a user equipment (UE) or an apparatus of a UE.

FIG. 9 is a diagram illustrating an example process performed, for example, at a network device or an apparatus of a network device.

FIGS. 10-11 are diagrams of example apparatuses for wireless communication.

### DETAILED DESCRIPTION

In a wireless network, cooperative or distributed computing may enable computational tasks to be shared among multiple devices within a network. Such an approach may leverage computational power from various devices, such as smartphones, tablets, and smartwatches, to perform computational operations. For example, such cooperative or distributed computing approaches may be utilized for a device (e.g., a user equipment (UE)) with limited computational resources (e.g., due to relatively low battery levels, relatively high current processing loads, or the like) or for devices seeking to run complex or resource-intensive applications (e.g., large language models (LLMs), extended reality (XR) applications, or on-device artificial intelligence or machine learning (AI/ML) training, among other examples), where such applications may utilize a relatively large proportion of on-device resources (e.g., computational resources, power resources, or the like). Similarly, the cooperative or distributed computing approaches may enable the use of idle computational resources from other devices, thereby improving efficient usage of computational resources across a network.

Furthermore, the mechanisms for a UE to request computational resources from the network or other devices are associated with higher-layer signaling, which can incur significant delays and limit the control that a radio access network (RAN) might have over the process of implementing cooperative or distributed computing across devices. Additionally, the mechanisms for a UE to request computational resources from the network may lack a clear protocol by which the network may communicate the acceptance or rejection of the computational requests to the UE. As a result, such a lack of clarity may lead to uncertainty and inefficiency in a process of enabling cooperative or distributive computing.

Various aspects relate generally to enabling a UE to utilize idle computing resources from other devices, by enabling communications between the UE and a network device concerning a request by the UE for additional computing resources. Some aspects more specifically relate to the UE sending a compute request to the network device, requesting additional computing resources from a serving device for performing a computational task, and subsequently receiving a response from the network device indicating the availability of the additional computing resources. In some aspects, the UE may send detailed information about the computational task, including the type of computational task, the computing type associated with the task, or security conditions associated with the computational task. This information may be sent in various states of the UE, such as when the UE is in an radio resource control (RRC)-IDLE, RRC-INACTIVE, or RRC-CONNECTED state, using different signaling types (e.g., physical random access channel (PRACH) messages, uplink control messages, scheduling request messages, or RRC messages, among other examples). The UE may also indicate specific time periods within which the network device is to accept or reject the compute request.

Additionally, in some aspects, before sending the compute request, the UE may send one or more sets of information associated with computational tasks to the network device, and the compute request may then indicate a set of information that is relevant to the current task. In some aspects, the network device's response, to the UE, may include an acceptance, denial, or an indication associated with the compute request in order to provide clear feedback to the UE. Additionally, in some aspects, the compute request may be sent directly to a network computing service function (NWCSF), or the network device may send a message to the NWCSF, including information associated with the compute request.

Particular aspects of the subject matter described in this disclosure can be implemented to realize one or more of the following potential advantages. In some examples, the described techniques can be used to request computing resources in a flexible and dynamic manner, thereby improving efficiency of network resource utilization by distributing computational loads across devices with available computational capacity. This distribution of computational loads may conserve processing resources and reduce demand on UE resources (e.g., on-device processing and power usage) and on network resources (e.g., MEC applications or the like), which can result in decreased network traffic and reduced latency for resource-intensive tasks. Additionally, where the UE sends, to the network node before sending the compute request, one or more sets of information associated with computational tasks to the network device, the UE may reduce the transmission overhead associated with each compute request. Additionally, by sending the compute request or information associated with the compute request to an NWCSF, the network may centralize the management of computing resources, allowing for optimized allocation based on current network conditions and the conditions associated with the computational tasks.

The use of various signaling methods or types for the UE to request computing resources enables adaptive power consumption and resource allocation based on an urgency or a priority condition associated with the computational task. This adaptability enables the UE to conserve energy by entering a low-power state when appropriate, or to expedite resource allocation for time-sensitive tasks, thereby conserving battery resources and improving the overall efficiency of network communications. Additionally, the utilization of lower-layer signaling mechanisms enables rapid acquisition of computing resources, which may enable computational tasks to be performed for UEs with limited processing capabilities (e.g., due to a current processing load associated with the UE), for UEs with a relatively low battery level, or for applications associated with low-latency processing. As a result, the described techniques may conserve network resources by reducing communication overhead and increasing the speed at which computing resources are allocated and utilized. As a result, some examples described herein may allow for increased efficiency and efficacy associated with the use of distributed computing resources, thereby lowering the computational or power-usage burden on individual UE hardware and improving the management of network computational demands. 5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing (MEC), millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or AI/ML, among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

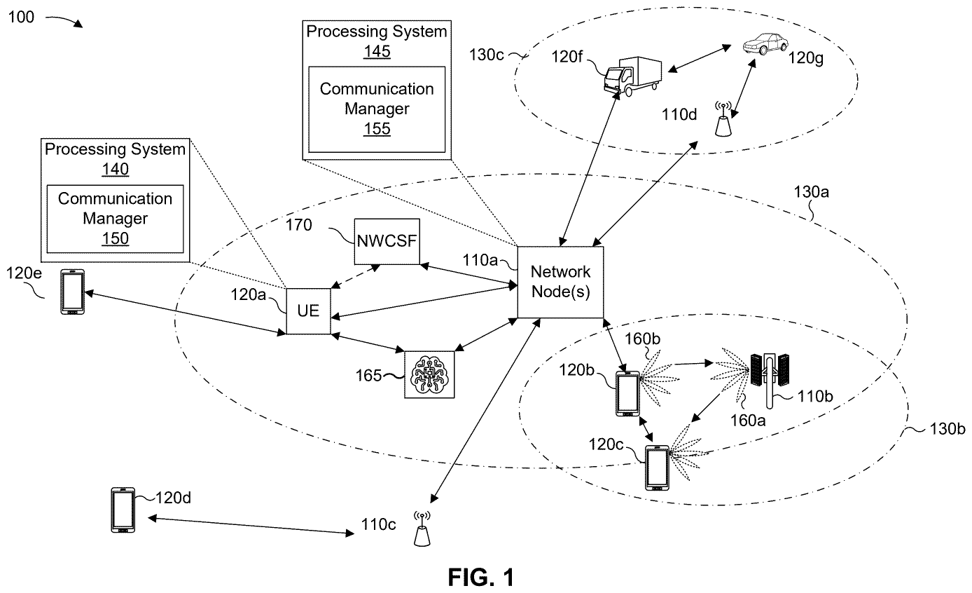

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a, a network node 110b, a network node 110c, and a network node 110d (each of which also may be referred to herein simply as a “network node 110”). The network nodes 110 may support communications with multiple UEs 120. For example, in FIG. 1, the network nodes 110 support communication with a UE 120a, a UE 120b, a UE 120c, a UE 120d, a UE 120f, and a UE 120g (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR 4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a RAN. In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110c (for example, a relay network node) may communicate with the network node 110a (for example, a macro network node) and the UE 120d in order to facilitate communication between the network node 110a and the UE 120d (for example, when the UE 120d is outside a coverage area of the cell 130a provided by the network node 110a). Additionally, or alternatively, a UE 120 may be or may operate as a relay that can relay transmissions to or from other UEs 120 or other wireless communication devices. A UE 120 that relays communications may be referred to as a UE relay or a relay UE, among other examples.

In some examples, a relay network node 110 may include an electromagnetic radiation reflective component that can be used to relay (for example, reflect) signals from a first other network node 110 to a second other network node 110 or a UE 120. Such a relay network node 110 can include, for example, a radio frequency reflection array configured to perform radio frequency reflection functions. The electromagnetic radiation reflective array can be, for example, a reconfigurable intelligent surface (RIS) (which also can be referred to as an intelligent reflective surface (IRS)).

In some examples, two or more UEs 120 (for example, shown as UE 120a and UE 120e or the UE 120f and the UE 120g) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an uplink communication to a network node 110, which then transmits the data to the UE 120e in a downlink communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, or vehicle-to-pedestrian (V2P) protocols), or mesh network communication protocols. In some deployments and configurations, a network node 110 may schedule or allocate resources for sidelink communications between UEs 120 in the wireless communication network 100. For example, the cell 130c may include a V2X network supported by the network node 110d. In some examples, the network node 110d may be a roadside unit or other device deployed in the V2X network. In some other deployments and configurations, a UE 120 (instead of a network node 110) may perform, or collaborate or negotiate with one or more other UEs to perform, scheduling operations, resource selection operations, or other operations for sidelink communications. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), or a physical sidelink feedback channel (PSFCH).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may send, to a network device, a compute request that requests additional computing resources from a serving device for performing a computational task; and receive, from the network device, a response to the compute request indicating an availability of the additional computing resources. Additionally, or alternatively, the communication manager 150 may perform one or more other operations described herein.

In some aspects, the network device (e.g., network node 110) may include a communication manager 155. As described in more detail elsewhere herein, the communication manager 155 may receive, from a UE 120, a compute request that requests additional computing resources from a serving device for performing a computational task; and send, to the UE 120, a response to the compute request indicating an availability of the additional computing resources. Additionally, or alternatively, the communication manager 155 may perform one or more other operations described herein.

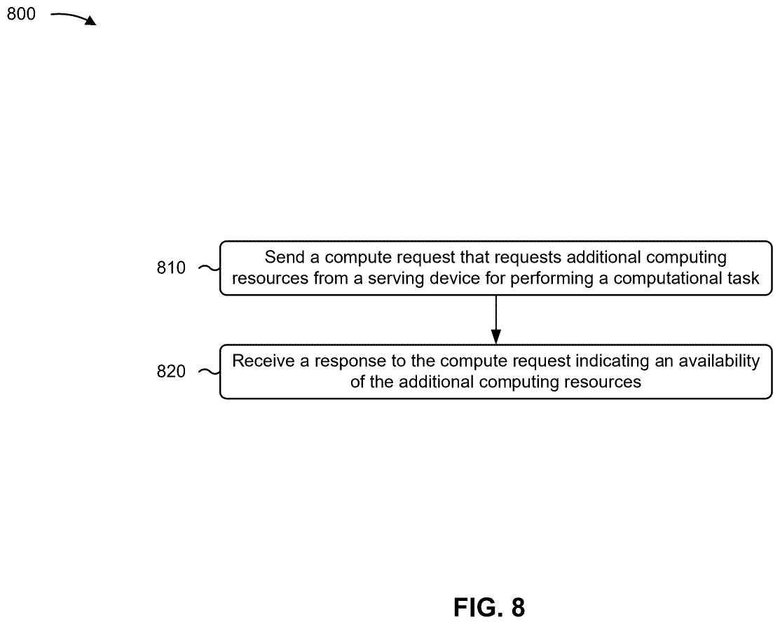

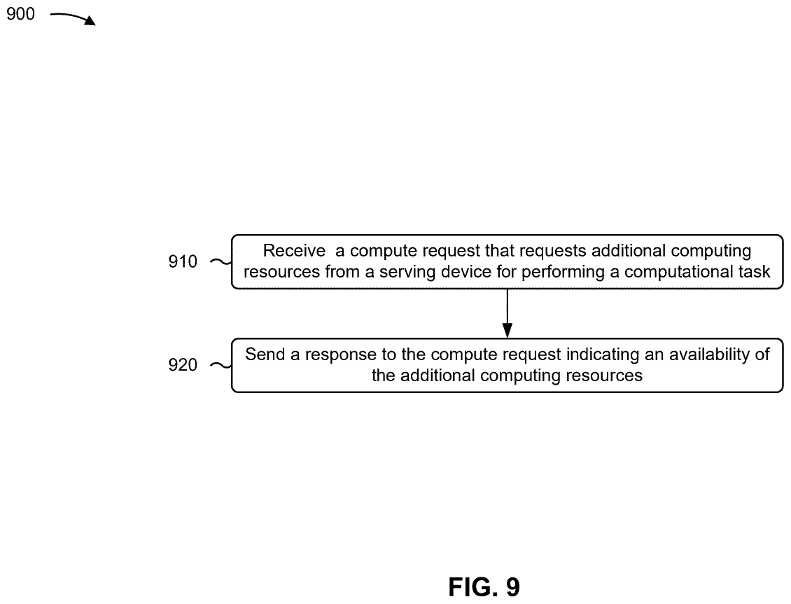

The network node 110, the processing system 145 of the network node 110, the UE 120, the processing system 140 of the UE 120, or any other component(s) of FIG. 1 may implement one or more techniques or perform one or more operations associated with requests for computational resource allocation, as described in more detail elsewhere herein. For example, the processing system 145 of the network node 110, or the processing system 140 of the UE 120 may perform or direct operations of, for example, process 800 of FIG. 8, process 900 of FIG. 9, or other processes as described herein (alone or in conjunction with one or more other processors). In some aspects, the network device described herein is the network node 110, is included in the network node 110, or includes one or more components of the network node 110 shown in FIG. 1. Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 800 of FIG. 8, process 900 of FIG. 9, or other processes as described herein. In some examples, executing instructions may include running the instructions, converting the instructions, compiling the instructions, or interpreting the instructions, among other examples.

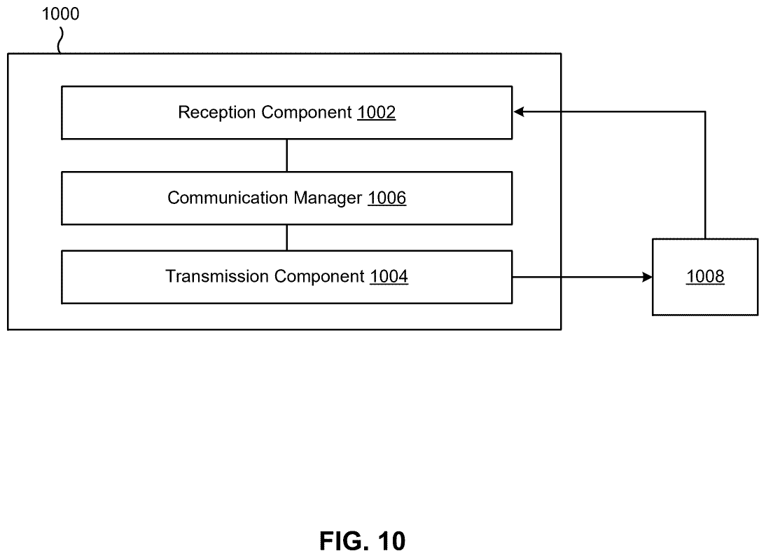

In some aspects, the UE 120 includes means for sending, to a network device (e.g., network node 110), a compute request that requests additional computing resources from a serving device for performing a computational task; or means for receiving, from the network device, a response to the compute request indicating an availability of the additional computing resources. The means for the UE 120 to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

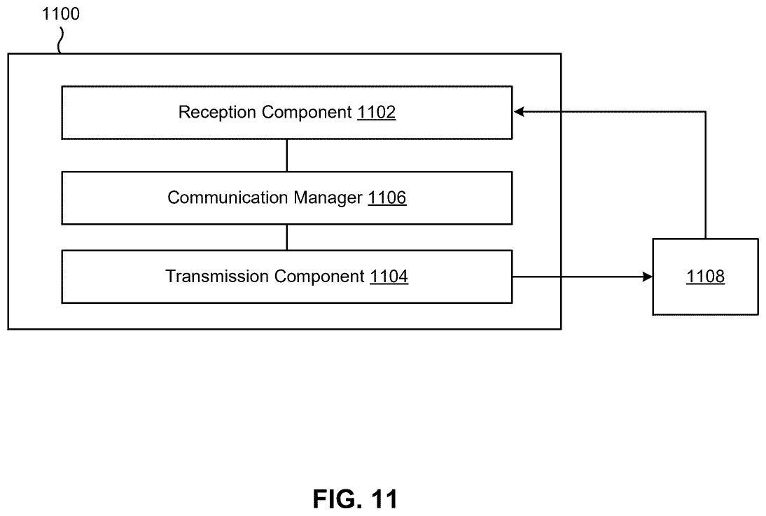

In some aspects, the network device (e.g., network node 110) includes means for receiving, from a UE 120, a compute request that requests additional computing resources from a serving device for performing a computational task; or means for sending, to the UE 120, a response to the compute request indicating an availability of the additional computing resources. In some aspects, the means for the network device to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

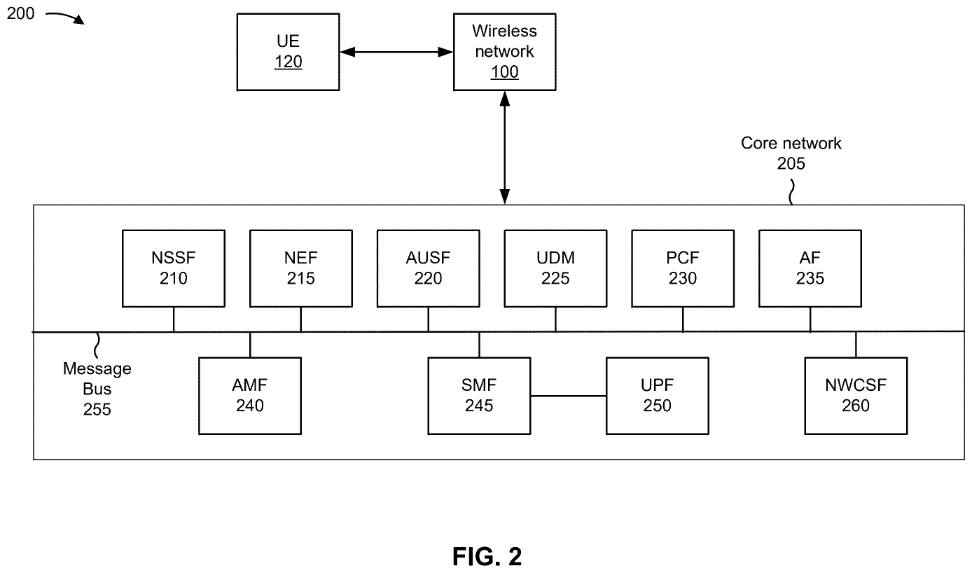

FIG. 2 is a diagram of an example 200 of a core network 205 configured to provide network slicing. As shown in FIG. 2, example 200 may include a UE 120, a wireless communication network 100, and a core network 205. Devices or networks of example 200 may interconnect via wired connections, wireless connections, or a combination thereof.

The wireless communication network 100 may support, for example, a cellular radio access technology (RAT). The network 100 may include one or more network nodes, such as base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network nodes that can support wireless communication for the UE 120. The network 100 may transfer traffic between the UE 120 (e.g., using a cellular RAT), one or more network nodes (e.g., using a wireless interface or a backhaul interface, such as a wired backhaul interface), or the core network 205. The wireless communication network 100 may provide one or more cells that cover geographic areas.

In some aspects, the wireless communication network 100 may perform scheduling or resource management for the UE 120 covered by the network 100 (e.g., the UE 120 covered by a cell provided by the wireless communication network 100). In some aspects, the wireless communication network 100 may be controlled or coordinated by a network controller which may perform load balancing or network-level configuration, among other examples. As described above in connection with FIG. 1, the network controller may communicate with the network 100 via a wireless or wireline backhaul. In some aspects, the network 100 may include a network controller, a self-organizing network (SON) module or component, or a similar module or component. Accordingly, the network 100 may perform network control, scheduling, or network management functions (e.g., for uplink, downlink, or sidelink communications of the UE 120 covered by the network 100).

In some aspects, the core network 205 may include an example functional architecture in which systems or methods described herein may be implemented. For example, the core network 205 may include an example architecture of a fifth generation (5G) next generation (NG) core network included in a 5G wireless telecommunications system. Although the example architecture of the core network 205 shown in FIG. 2 may be an example of a service-based architecture, in some aspects, the core network 205 may be implemented as a reference-point architecture or a 4G core network, among other examples.

As shown in FIG. 2, the core network 205 may include a number of functional elements. The functional elements may include, for example, a network slice selection function (NSSF) 210, a network exposure function (NEF) 215, an authentication server function (AUSF) 220, a unified data management (UDM) component 225, a policy control function (PCF) 230, an application function (AF) 235, an access and mobility management function (AMF) 240, a session management function (SMF) 245, a user plane function (UPF) 250, or an NWCSF 260 among other examples. These functional elements may be communicatively connected via a message bus 255. Each of the functional elements shown in FIG. 2 may be implemented on one or more devices associated with a wireless telecommunications system. In some implementations, one or more of the functional elements may be implemented on physical devices, such as an access point, a base station, or a gateway, among other examples. In some implementations, one or more of the functional elements may be implemented on a computing device of a cloud computing environment.

The NSSF 210 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 or communications to and from the UE 120. Network slicing may efficiently provide communications for different types of services with different service standards.

The NSSF 210 may determine a set of network slice policies to be applied at the wireless communication network 100. For example, the NSSF 210 may apply one or more UE route selection policy (URSP) rules. In some aspects, the NSSF 210 may select a network slice based on a mapping of a data network name (DNN) field included in a route selection description (RSD) to the DNN field included in a traffic descriptor selected by the UE 120. By providing network slicing, the NSSF 210 allows an operator to deploy multiple substantially independent end-to-end networks potentially with the same infrastructure. In some implementations, each slice may be customized for different services.

The NEF 215 may include one or more devices that support exposure of capabilities or events in the wireless telecommunications system to help other entities in the wireless telecommunications system discover network services. The AUSF 220 may include one or more devices that act as an authentication server and support the process of authenticating the UE 120 in the wireless telecommunications system.

The UDM 225 may include one or more devices that store user data and profiles in the wireless telecommunications system. In some aspects, the UDM 225 may be used for fixed access or mobile access, among other examples, in the core network 205.

The PCF 230 may include one or more devices that provide a policy framework that incorporates network slicing, roaming, packet processing, or mobility management, among other examples. In some aspects, the PCF 230 may include one or more URSP rules used by the NSSF 210 to select network slice instances for the UE 120.

The AF 235 may include one or more devices that support application influence on traffic routing, access to the NEF 215, or policy control, among other examples. The AMF 240 may include one or more devices that act as a termination point for non-access stratum (NAS) signaling or mobility management, among other examples. In some aspects, the AMF may request the NSSF 210 to select network slice instances for the UE 120, e.g., at least partially in response to a request for data service from the UE 120.

The SMF 245 may include one or more devices that support the establishment, modification, and release of communication sessions in the wireless telecommunications system. For example, the SMF 245 may configure traffic steering policies at the UPF 250 or enforce UE internet protocol (IP) address allocation and policies, among other examples. In some aspects, the SMF 245 may provision the network slice instances selected by the NSSF 210 for the UE 120.

The UPF 250 may include one or more devices that serve as an anchor point for intraRAT or interRAT mobility. In some aspects, the UPF 250 may apply rules to packets, such as rules pertaining to packet routing, traffic reporting, or handling user plane QoS, among other examples.

The message bus 255 may be a logical or physical communication structure for communication among the functional elements. Accordingly, the message bus 255 may permit communication between two or more functional elements, whether logically (e.g., using one or more APIs, among other examples) or physically (e.g., using one or more wired or wireless connections).

The NWCSF 260 may be a component within a wireless communication network that provides additional computational resources and services to UEs 120 or other network elements. The NWCSF 260 may be utilized as a centralized or distributed computing resource that may be dynamically allocated to support various computational tasks (e.g., data processing, AI/ML models or algorithms, or the like). By offloading these tasks to the NWCSF 260, network components (e.g., a UE 120, a network node, or other network components, among other examples) may conserve processing power and battery life. In some examples, the NWCSF 260 may be integrated as part of the core network 205, edge computing nodes (e.g., MEC nodes), or cloud-based platforms, among other examples. In addition to providing computational resources, the NWCSF 260 may also be utilized in managing security and privacy configurations or actions associated with data processing. For example, the NWCSF 260 can enforce security policies, perform data encryption and decryption, or ensure compliance with regulations, among other examples.

The number and arrangement of devices and networks shown in FIG. 2 are provided as an example. In practice, there may be additional devices or networks, fewer devices or networks, different devices or networks, or differently arranged devices or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of example 200 may perform one or more functions described as being performed by another set of devices of example environment 200.

As indicated above, FIG. 2 is provided as an example. Other examples may differ from what is described with regard to FIG. 2.

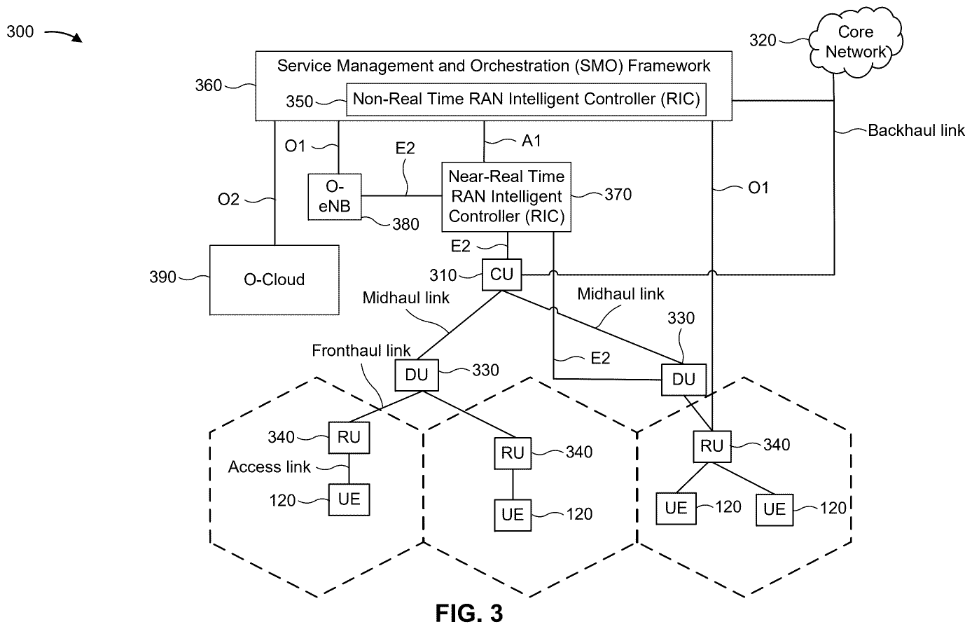

FIG. 3 is a diagram illustrating an example disaggregated network node architecture 300. One or more components of the example disaggregated network node architecture 300 may be, may include, or may be included in one or more network nodes (such one or more network nodes 110). The disaggregated network node architecture 300 may include a CU 310 that can communicate directly with a core network 320 via a backhaul link, or that can communicate indirectly with the core network 320 via one or more disaggregated control units, such as a non-real-time (Non-RT) RAN intelligent controller (RIC) 350 associated with a Service Management and Orchestration (SMO) Framework 360 or a near-real-time (Near-RT) RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated network node architecture 300, including the CUs 310, the DUs 330, the RUs 340, the Near-RT RICs 370, the Non-RT RICs 350, and the SMO Framework 360, may include one or more interfaces or may be coupled with one or more interfaces for transmitting or receiving signals, such as data, control information, or reference signals via a wired or wireless transmission medium. In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, or a Near-RT RIC 370. In some aspects, the SMO Framework 360 may communicate with a hardware aspect of a 4G RAN, a 5G NR RAN, or a 6G RAN, such as an open eNB (O-eNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, or policy-based guidance of applications or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, or an O-eNB 380 with the Near-RT RIC 370. In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

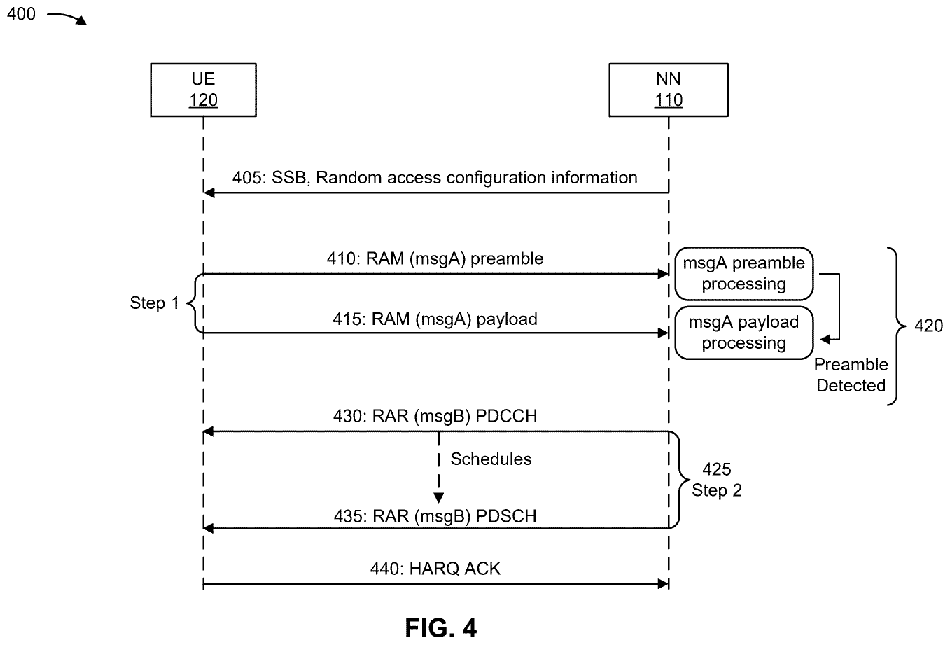

FIG. 4 is a diagram illustrating an example 400 of a two-step random access procedure. As shown in FIG. 4, a network node 110 and a UE 120 may communicate with one another to perform the two-step random access procedure.

As shown by reference number 405, the network node 110 may transmit, and the UE 120 may receive, one or more synchronization signal blocks (SSBs) and random access configuration information. In some aspects, the random access configuration information may be transmitted in or indicated by system information (e.g., in one or more system information blocks (SIBs)) or an SSB, such as for contention-based random access. Additionally, or alternatively, the random access configuration information may be transmitted in an RRC message or a PDCCH order message that triggers a random access channel (RACH) procedure, such as for contention-free random access. The random access configuration information may include one or more parameters to be used in the two-step random access procedure, such as one or more parameters for transmitting a random access message (RAM) or receiving a random access response (RAR) to the RAM.

As shown by reference number 410, the UE 120 may transmit, and the network node 110 may receive, a RAM preamble. As shown by reference number 415, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, UCI, or a PUSCH transmission).

As shown by reference number 420, the network node 110 may receive the RAM preamble transmitted by the UE 120. If the network node 110 successfully receives and decodes the RAM preamble, the network node 110 may then receive and decode the RAM payload.

As shown by reference number 425, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, or contention resolution information.

As shown by reference number 430, as part of the second step of the two-step random access procedure, the network node 110 may transmit a PDCCH communication for the RAR. The PDCCH communication may schedule a physical downlink shared channel (PDSCH) communication that includes the RAR. For example, the PDCCH communication may indicate a resource allocation (e.g., in DCI) for the PDSCH communication.

As shown by reference number 435, as part of the second step of the two-step random access procedure, the network node 110 may transmit the PDSCH communication for the RAR, as scheduled by the PDCCH communication. The RAR may be included in a MAC protocol data unit (PDU) of the PDSCH communication. As shown by reference number 440, if the UE 120 successfully receives the RAR, the UE 120 may transmit a hybrid automatic repeat request (HARQ) acknowledgement (ACK).

As indicated above, FIG. 4 is provided as an example. Other examples may differ from what is described with regard to FIG. 4.

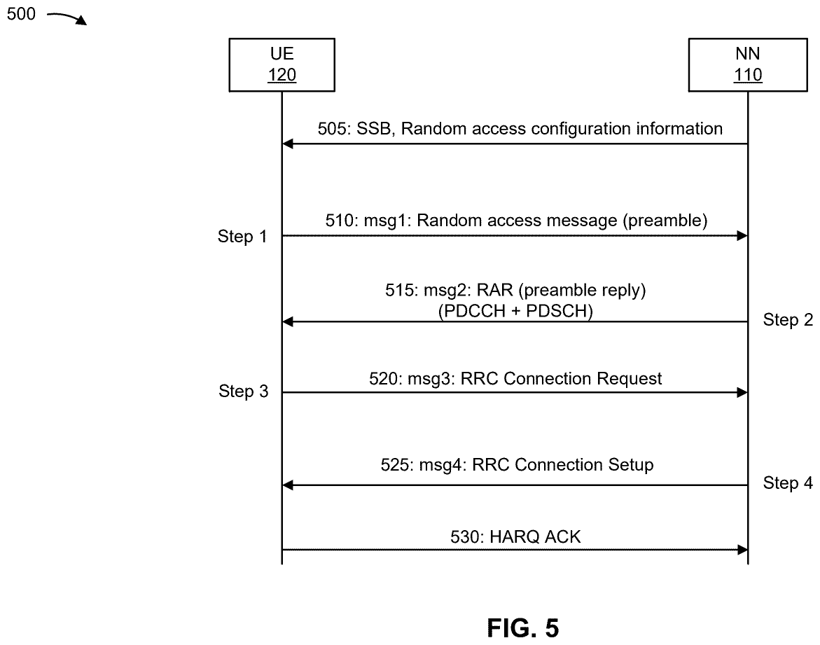

FIG. 5 is a diagram illustrating an example of a four-step random access procedure. As shown in FIG. 5, a network node 110 and a UE 120 may communicate with one another to perform the four-step random access procedure.

As shown by reference number 505, the network node 110 may transmit, and the UE 120 may receive, one or more SSBs and random access configuration information. In some aspects, the random access configuration information may be transmitted in or indicated by system information (e.g., in one or more SIBs) or an SSB, such as for contention-based random access. Additionally, or alternatively, the random access configuration information may be transmitted in an RRC message or a PDCCH order message that triggers a RACH procedure, such as for contention-free random access. The random access configuration information may include one or more parameters to be used in the random access procedure, such as one or more parameters for transmitting a RAM or one or more parameters for receiving an RAR.

As shown by reference number 510, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 515, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication.

As shown by reference number 520, the UE 120 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (e.g., an RRC connection request).

As shown by reference number 525, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by reference number 530, if the UE 120 successfully receives the RRC connection setup message, the UE 120 may transmit a HARQ ACK.

As indicated above, FIG. 5 is provided as an example. Other examples may differ from what is described with regard to FIG. 5.

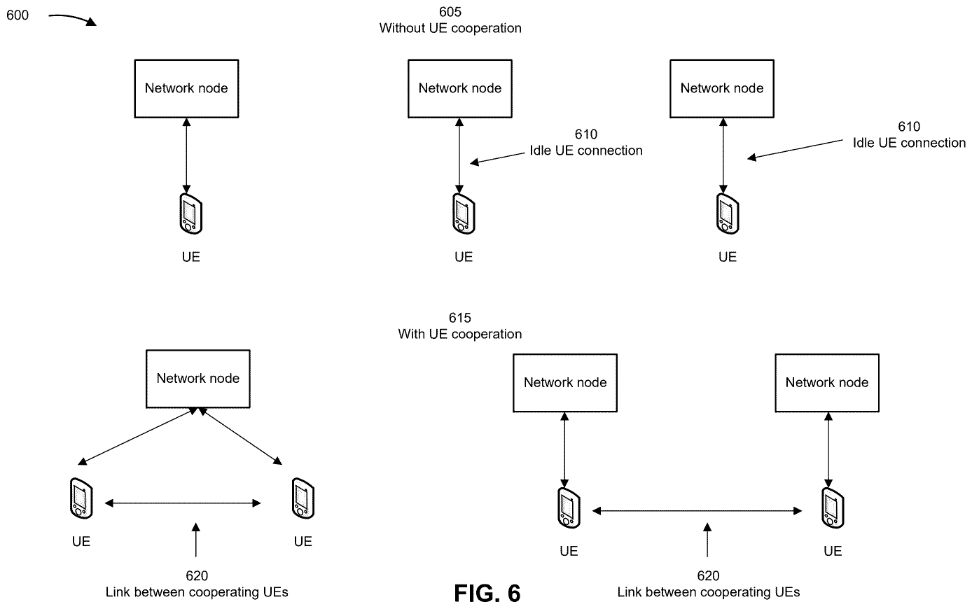

FIG. 6 is a diagram illustrating an example 600 of device cooperation for distributed or cooperative computing.

In a wireless network, device cooperation may include multiple UEs or other network device performing distributed or cooperative computations to improve communication coverage and computational capabilities. For example, device cooperation may utilize a plurality of UEs for DL or UL, thereby enabling continuous communication in areas with weak signals or coverage gaps. By utilizing the proximity of UEs, the network can dynamically adjust and optimize coverage. Additionally, such a cooperative approach allows the network to distribute tasks based on the energy profiles of the UEs, thereby extending the overall battery life of the devices within the network. In some examples, in a multi-transmission and reception point (M-TRP) operation, UEs may perform as TRPs, where the UE may act as a relay or a transmission point to serve other UEs in the network, thereby facilitating joint service to multiple UEs.

Similarly, in some examples, UEs or other network devices (e.g., application servers, smartwatches, smart devices, tablets, laptops, desktop computers, IoT devices, or other network devices, among other examples) may share computing resources in order to support applications including XR and AI/ML models. For example, running LLMs for inference or on-device AI/ML training for communications can be distributed across multiple devices, utilizing their combined computing and memory resources. Similarly, for example, online device learning (e.g., including continuous training and model updates) may benefit from device cooperation. By utilizing network slicing and proximity services (NSP), such devices can perform ongoing prototyping and model updates efficiently, enabling AI/ML models to be continuously updated.

Additionally, device cooperation may enable computational distribution, which may include balancing or rebalancing computing resources according to available resources. For example, computational tasks for a smartwatch may be offloaded to a more powerful device (e.g., a smartphone). Similarly, computational tasks for a device having relatively low battery levels or relatively high computational loads may be offloaded to one or more devices having relatively higher battery levels or relatively lower computational loads. In some examples, such computational task offloading can be managed with a relatively flexible timeline, making it feasible for devices with limited computational capabilities to perform complex tasks.

Similarly, for example, MEC is a core network architecture and signaling configuration that enables processing of data at an “edge” of the network (e.g., at a network node connected to a UE), thereby performing such computing in a relatively close proximity to the UE connected to an associated network node. Such proximity reduces latency, improves performance, and enables real-time applications like IoT, gaming, and video streaming. However, where the computational entity is in a RAN (e.g., a distributed UE providing computing resources to another device in the network), a lower-layer request may be more efficient for reducing latency and reducing power consumption relative to the network-layer signaling utilized in MEC.

Accordingly, network devices (e.g., UEs, laptops, tablets, or the like) with unused or underutilized computing resources may offer computational services to client devices (e.g., client UEs). Such distribution or sharing of computational services may be utilized in conjunction with MEC or independent of MEC. In some examples, devices providing distributed or cooperative computational services may be in close proximity (e.g., communicating via Wi-Fi, sidelink, a local mesh network, or the like), or may be located relatively far from each other (e.g., communicating via a core network or via the internet, among other examples).

For example, as shown by reference number 605, an example network may operate without UE cooperation, and each UE may utilize its own respective computing resources. In some examples, a network node (e.g., network node 110) may communicate directly with a UE (e.g., UE 120) without utilizing additional resources from other UEs. In this scenario, each UE may perform computational tasks independently, or the network node may be associated with performing some computational tasks associated with the UE (e.g., via an MEC). For example, a network node may selectively offload tasks to nearby computing nodes or edge servers (e.g., MECs). Such a scenario may include the network node identifying tasks that can be efficiently handled by external nodes and distributing those tasks to enhance overall processing efficiency.

As shown by reference number 610, one or more UEs in the network may be associated with an idle connection to one or more network nodes, or the one or more UEs may be associated with underutilized computing resources. For example, such an idle UE may be connected to the network node but may not be actively engaged in computational tasks. This idle state allows the idle UE to remain connected to the network while conserving power and resources. Additionally, or alternatively, an idle UE may periodically update its status and available resources to the network node, even when not actively engaged in tasks.

As shown by reference number 615, the network may facilitate distributed or cooperative computation among a plurality of UEs in the network. For example, the network node may utilize computing resources from multiple UEs to perform computational tasks more efficiently. Additionally, or alternatively, the network node may participate in cooperative computational operation with one or more UEs. For example, the network node may distribute computational tasks across multiple UEs, utilizing their resources for enhanced performance and reduced latency, in addition to the computational tasks being at least partly performed at the network node (e.g., at a MEC associated with the network node). Additionally, or alternatively, in a cooperative computational scenario, the network node may dynamically allocate tasks based on the current computational load and resource availability of each UE.

As shown by reference number 620, the network node may facilitate a link between cooperating UEs. For example, UEs may communicate with one another to share computing resources, enabling distributed or cooperative computing. This link between UEs may be established via direct communication or through the network node, thereby expanding computational capabilities associated with distributed or cooperative computing. Additionally, or alternatively, the communication link between cooperating UEs may be established via various wireless communication protocols.

However, the mechanisms for a UE to request computing resources from the network or from other devices are largely confined to higher-layer signaling, which can incur significant delays and limit the control that a RAN might have over the process. Additionally, the mechanisms for a UE to request computing resources from the network may lack a clear protocol by which the network may communicate the acceptance or rejection of the computational request to the UE. As a result, such a lack of clarity may lead to uncertainty and inefficiency in the process of enabling cooperative or distributive computing.

As indicated above, FIG. 6 is provided as an example. Other examples may differ from what is described with respect to FIG. 6.

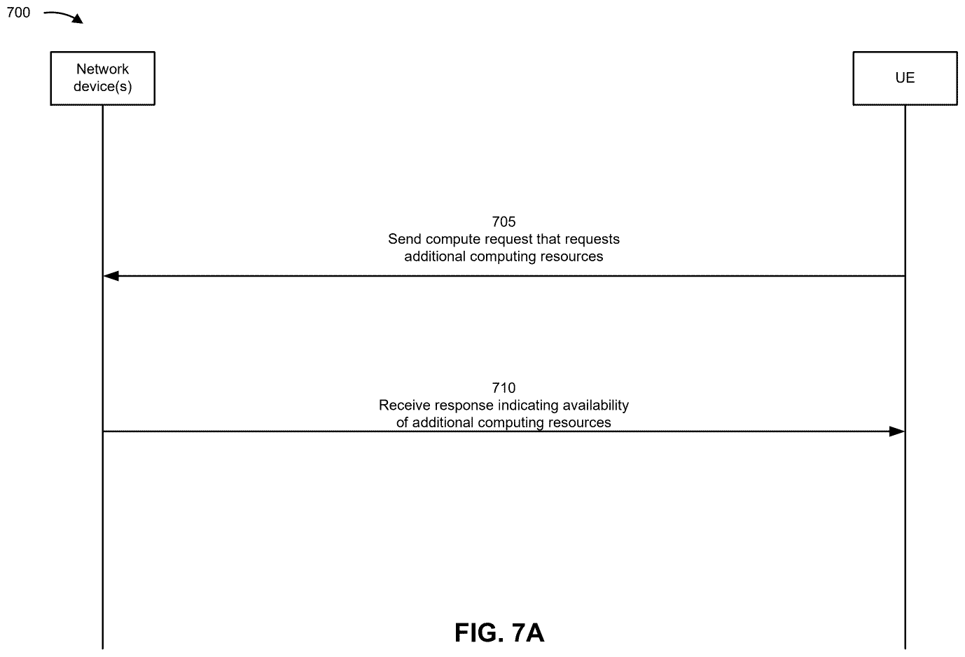

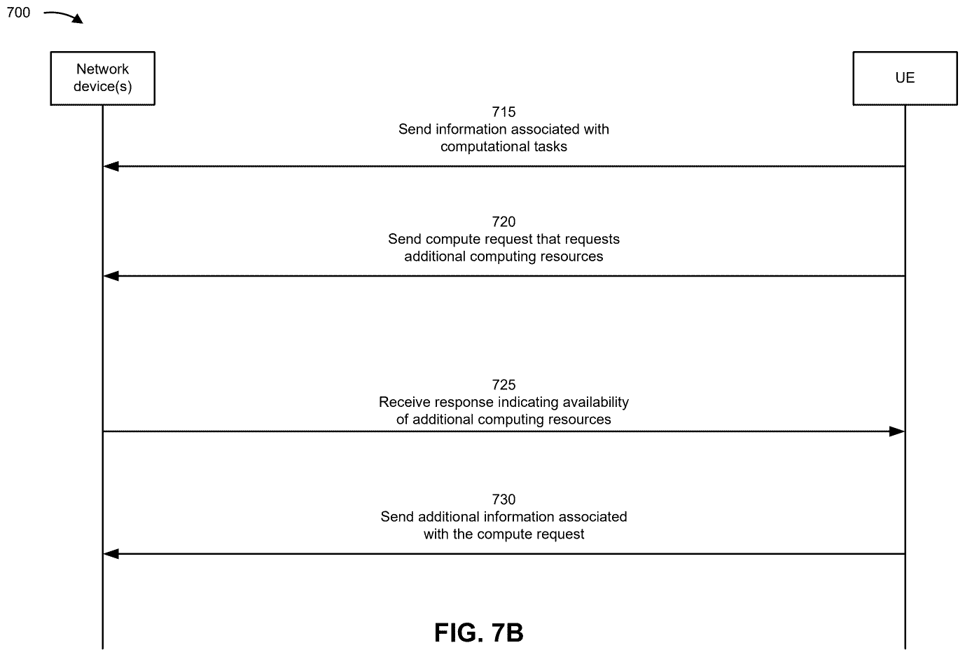

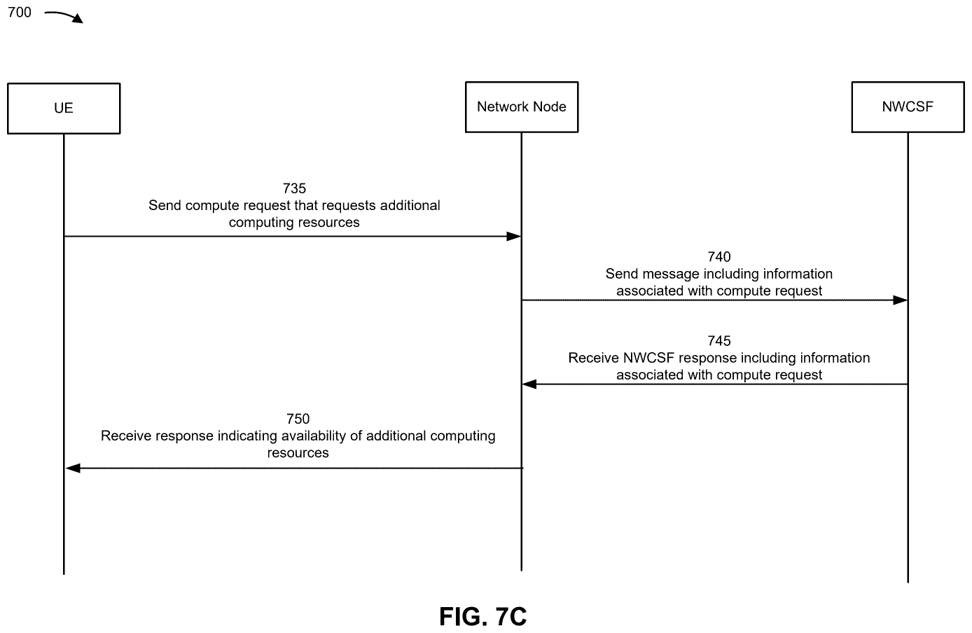

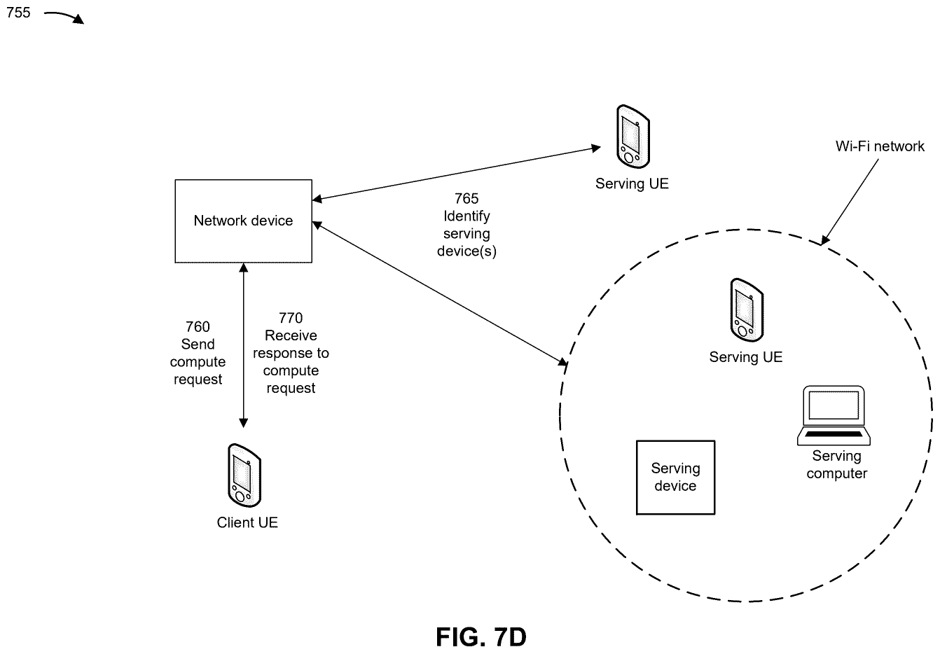

FIGS. 7A-7D are diagrams illustrating example 700 and example 755 associated with requests for computational resource allocation. As shown in FIGS. 7A-7D, a network device (e.g., network node 110) and a UE (e.g., UE 120) may communicate with one another, and the network device or the UE may communicate with an NWCSF (e.g., NWCSF 170 or NWCSF 260) or with one or more functions or components associated with a core network (e.g., core network 205).

As shown in FIG. 7A, and by reference number 705, a UE may send, and a network device may receive, a compute request that requests additional computing resources from a serving device for performing a computational task. In some aspects, the compute request may include a request for additional computational power to a network device for executing a computational task. For example, the UE may request computing resources to perform a task in a scenario in which the UE has limited processing resources (e.g., due to one or more additional processing loads at the UE). Additionally, or alternatively, the UE may request computing resources to perform a task in a scenario in which the UE has relatively low battery levels, thereby enabling the UE to conserve battery resources by offloading computational tasks to a serving device.

In some aspects, the “additional computing resources” may refer to processing, memory, or other computational resources (e.g., external to the requesting UE) that are not currently available to or allocated for use by the requesting UE. Such resources may be provided by other devices (e.g., UEs), network nodes, edge servers, or cloud servers, and may be requested based on the UE determining that the UE's own resources are insufficient to perform a given computational task or that one or more of the UE's own resource levels satisfy a threshold for requesting additional computing resources. For example, in a case in which the UE's battery level satisfies (e.g., is less than) a battery threshold, the UE may request additional computing resources. In some aspects, the term “additional computing resources” may encompass resources external to the UE, including resources that are idle, underutilized, or otherwise available for allocation to the UE for cooperative or distributed computing.

Furthermore, the compute request may indicate a type, quantity, or performance characteristic of the computing resources being requested, such as processing power, memory capacity, computation accuracy, or latency configurations. The request may be triggered based on the UE determining that the UE's own resources are insufficient, for example, due to high processing load, low battery, or the nature of the computational task (e.g., running a large language model or performing real-time AI/ML inference).

In some aspects, the compute request may include details associated with the compute request. In some aspects, the details may include information associated with the type of computing resources (e.g., in terms of total operations per second (TOPs), memory, or computational accuracy including different bit widths for computation, among other examples) associated with the compute request and associated computational tasks. Additionally, the details may include information associated with computing tasks indicated for solving a problem or a class of problems (e.g., multiplying relatively large matrices, performing FFT operations, or obtaining principal eigenvectors, among other examples). Additionally, or alternatively, the compute request may indicate one or more types of computing services that are associated with the computational tasks associated with the compute request. For example, the compute request may indicate that the computational tasks are associated with XR applications or LLM training, among other examples. As a result, by indicating the type of computing service, the network device may efficiently locate and allocate computing resources that are suitable for the type of computing task associated with the compute request.

Additionally, in some aspects, the details about the compute request may include information associated with one or more time conditions or time thresholds. For example, the information may be associated with one or more latency bounds for the compute request associated with the computational tasks (e.g., a threshold time period for completing the computational tasks), which may result in reduced latency in low-latency applications. Similarly, for example, the compute request may indicate a time period within which the network device is to accept or reject the compute request.

Additionally, in some aspects, the details about the compute request may include information associated with security conditions. For example, the UE may indicate that the computational task, associated with the compute request, involves sensitive data associated with one or more security protocols. As a result, the network device may facilitate computing resources from devices that comply with the security conditions. For example, the network device may facilitate computing resources from edge devices, cloud servers, or the like, and may avoid facilitating computing resources from personal devices (e.g., personal UEs).

Additionally, or alternatively, the UE may transmit a compute request to a network device, which then routes the request to appropriate serving devices. For example, the network device may find a serving device or a set of serving devices capable of providing computing resources associated with the compute request. Additionally, or alternatively, the network device may redirect or forward the compute request to a serving device or a set of serving devices capable of providing computing resources associated with the compute request.

Additionally, or alternatively, the compute request may include context information associated with the UE or with the computational tasks associated with the compute request. For example, the context information may include information related to sensory processing at the UE, including information associated with data obtained from cameras, microphones, or other sensors. Additionally, or alternatively, the context information may include information related to applications currently running on the UE (e.g., gaming applications, AI/ML models, or real-time data analytics tools, among other examples). By providing this context information, the UE may enable the network device to allocate resources that are suitable for specific tasks, ensuring continuous and responsive sensory processing.

In some aspects, the UE may generate logs, error messages, or system notifications associated with the status of the compute request. These indicators may include confirmation of the request being sent, any errors that occurred during transmission, or updates on the acceptance or rejection of the request from the network. Such features ensure that users or the network are aware of the computational requests made by the UE and can take appropriate actions if needed.

In some aspects, the UE may be configured to send a compute request based on certain conditions or thresholds being satisfied. For example, the UE may monitor its battery level, processing load, or other performance metrics to determine when to offload computational tasks. For example, if the UE's battery level satisfies (e.g., falls below) a battery threshold or if the processing load satisfies (e.g., exceeds) a processing threshold, the UE may generate and send a compute request to the network device. These conditions and thresholds ensure that the UE efficiently manages its resources and leverages external computational power.

As shown by reference number 710, the network device may send, and the UE may receive, a response indicating an availability of additional computing resources. In some aspects, the response may indicate whether the compute request is accepted or rejected. Similarly, where the response indicates that the compute request is rejected, the response may indicate one or more causes associated with the rejection. For example, the response may indicate that an insufficient quantity of computing resources are available, that the available computing resources fail to satisfy one or more security conditions, or that the computing resources fail to satisfy one or more latency conditions, among other examples.

In some aspects, the response may indicate whether the requested computing resources are available, partially available, or unavailable. For example, the network device may indicate that a certain quantity of processing units are available. Additionally, or alternatively, the response may indicate an availability status of the additional computing resources, including any specific instructions for their utilization. For example, the notification may include steps for the UE to initiate use of the available resources.

Additionally, or alternatively, where the compute request was sent in a PRACH message, the network node may send the response to the compute request in a response to the RACH signal. For example, in a contention-based random access procedure, the network device may send the response as part of a msg4 message. Alternatively, in a contention-free random access procedure, the network device may send the response in an RAR message. Alternatively, in a 2-step RACH procedure, the network device may send the response in a msgB message. Accordingly, the network device may utilize a positive acknowledgment (e.g., an ACK) response based on the information provided by the UE in the compute request. For example, where the compute request excludes a request for an immediate connection with an UL grant, the response may exclude a DCI grant with an associated cell radio network temporary identifier (C-RNTI).

In some aspects, for compute requests sent while the UE is in an RRC-CONNECTED state, the network device may send a response utilizing DL control channels (e.g., PDCCH). In some aspects, the network device may utilize a DCI format to indicate only the request acceptance. For example, for a compute request associated with a load-sharing facility computational task, the UE may upload data associated with the computational tasks prior to sending the compute request (e.g., during a time period associated with relatively light network traffic or relatively light transmission overhead). After the network device locates a service device to perform the computing tasks, the network device may indicate to the UE that the compute request is accepted. Additionally, or alternatively, the network device may utilize a DCI format with UL scheduling to indicate the request acceptance, in addition to indicating the UL resource grant for the UE to send the data associated with the computational tasks. As a result, the network device can adapt such DCI formats to a set of UEs, enabling efficient communication and resource management. For example, in scenarios involving relatively large-scale computing tasks, the network can manage multiple UEs simultaneously, optimizing the allocation of computing resources.

Additionally, or alternatively, the network device may store a profile associated with each UE of one or more UEs associated with the network device, and the profile may be continuously or periodically updated. For example, the UE may provide updated profile information to the network device, the network device may update the profile information based on interaction with the UE, or the network device may obtain updated profile information from one or more other network devices, among other examples. In some aspects, the profile may include information associated with the respective UE, including computational capabilities (e.g., processing resources, memory capacity), resource usage patterns, or previous compute requests, among other examples.

For example, a profile may indicate that the associated UE frequently engages in tasks requiring relatively high levels of computing resources (e.g., running XR applications or performing real-time data analysis, among other examples). By keeping these profiles up-to-date, the network device may allocate resources more efficiently, thereby reducing latency. Additionally, such profiles may be used to enhance security and compliance with security policies. For example, where a UE's security policy specifies that computational tasks may only be delegated to edge servers or cloud servers, this information can be stored in the profile and referenced whenever a compute request is made. As a result, the network device can quickly and accurately respond to requests, providing the necessary resources while adhering to the associated security conditions.

In some aspects, the UE may utilize one or more types of signaling or messaging to send the compute request to the network device. In some aspects, the compute request may be sent in a PRACH message based on the UE being in an RRC-IDLE or an RRC-INACTIVE state. Furthermore, in some aspects, the UE may transition to a low-power state after sending the compute request, thereby conserving battery resources. After the UE has transitioned to the low-power state, the UE may monitor for a response, from the network device, via a paging message (e.g., where the response is time insensitive). After receiving the response from the network device, the UE may then send the data associated with the computational tasks associated with the compute request. For example, where the request is accepted, the UE can transition to an RRC-CONNECTED state and send the necessary data for computing. In some aspects, the compute request may also indicate a time period in which the network device is requested to provide an acceptance or a rejection of the compute request. For example, where the compute request is associated with a time-sensitive computational task, the UE may indicate the time period for acceptance or rejection of the compute request. Additionally, or alternatively, where the compute request is associated with one or more computational tasks that are configured at the network device (e.g., that are previously known at the network device), the PRACH message may include a relatively small quantity of bits to indicate which computational tasks are being requested.

In some aspects, where the UE and the network device are participating in a two-step RACH procedure, the UE may send the compute request (e.g., including any additional information associated with the computational task, including data for the computational task) in a PUSCH message associated with a msgA message. Additionally, or alternatively, the compute request may indicate that the UE is requesting an immediate RRC connection with an UL grant in order to send data associated with computational tasks associated with the compute request.

In some aspects, where the UE is in an RRC-CONNECTED state, the UE may send a compute request by utilizing an SR or a detailed computation status report (DCSR) mechanism. For example, the SR may include the compute request and a request for a communication UL grant, or the SR may be dedicated only for the compute request. In some aspects, the SR may be sent in a PUCCH or multiplexed with a PUSCH. This flexibility enables the UE to communicate its computational requests in a manner that is adaptable to the current network conditions and resource availability.

Additionally, the DCSR may include further information associated with the compute request, the type of task, requested or potential computational or memory resources, time or latency conditions or thresholds, or security conditions, among other examples. As a result, the UE may provide information associated with the computational tasks associated with the compute request, while maintaining efficient communications with the network device.

Additionally, or alternatively, the UE may utilize a MAC-CE to include additional information associated with the compute request. In some aspects, the MAC-CE may be a dedicated element with a new logical channel identifier (LCID) for compute requests. In some aspects, the UE may utilize an existing buffer status report (BSR) MAC-CE, including an indication that the BSR MAC-CE is for computation status reporting purposes (e.g., indicating additional information related to data associated with the compute request or the size of data associated with the compute request, indicated by the BSR).

For example, the MAC-CE may also indicate the status of the data (e.g., the size of the data) to be sent for the computational tasks associated with the compute request. Such information may enable the network device to allocate the appropriate resources to increase the processing efficiency of the data. By utilizing the MAC-CE, the UE may provide a structured or uniform communication type to indicate the computational tasks associated with the compute request, thereby increasing the communication efficiency between the UE and the network device.

Additionally, or alternatively, where the UE is in an RRC-CONNECTED state, the UE may utilize an RRC message to send the compute request. For example, the compute request may be included in a UE assistance information message. As a result, by utilizing RRC messages to send the compute request, the UE may communicate its requests within the RRC signaling framework, reducing the need for additional signaling configurations and enabling the network device to efficiently process the compute request.

As shown by FIG. 7B, and reference number 715, the UE may send, and the network device may receive, one or more sets of information associated with one or more computational tasks. For example, the UE may provide the information associated with one or more computational tasks to the network device during registration of the UE with a wireless network associated with the network device. As a result, the UE may later indicate one or more requested computational tasks (e.g., via a relatively small quantity of bits), and the network device may have already received information associated with the requested computational tasks.

For example, the UE may provide descriptions of the computational tasks, including the requested or potential processing resources associated with the computational tasks, the requested or potential memory associated with the computational tasks, or the expected duration of the computational tasks, among other examples. Additionally, or alternatively, the UE may send information related to the type of computational tasks associated with the compute request, indicating the associated processing capabilities and memory conditions. For example, the UE may indicate that the computational tasks involve complex image processing associated with a relatively high computational resource load, thereby enabling the network device to allocate resources suitable for the computational tasks.

Additionally, or alternatively, in some aspects, where the UE is in an RRC-CONNECTED state, the UE may send the compute request using a relatively small quantity of bits (e.g., 1 or 2 bits) in an UL control signal. For example, the UL control signal may be a dedicated compute request signal, and the bits may indicate one or more requested computational tasks associated with the one or more sets of information associated with the one or more computational tasks indicated, by the UE, to the network device.

As shown by reference number 720, the UE may send, and the network device may receive, a compute request that requests additional computing resources from a serving device for performing a computational task, as described herein. In some aspects, the compute request may indicate a set of information, of the one or more sets of information associated with the computational task. For example, the compute request may utilize one or more bits to indicate one or more of the sets of information that were provided to the network device as part of the UE sending, and the network device receiving, information associated with the computational task. As a result, communication overhead associated with the compute request may be reduced, where the UE may send a relatively small quantity of bits to indicate the computational task that is being requested.

As shown reference number 725, the network device may receive a response indicating the availability of the additional computing resources, as described herein. For example, the response may indicate whether the compute request is accepted or rejected.

As shown by reference number 730, the UE may send, and the network device may receive, additional information associated with the compute request. In some aspects, the additional information may be sent in a msg3 message during a RACH procedure (e.g., where the compute request was sent earlier in the RACH procedure). For example, the UE may provide further details about the computational task, such as data to be processed or security conditions associated with the computational task. For example, the UE may send data files that need to be processed along with encryption keys associated with the data files. Additionally, or alternatively, the UE may provide supplementary information to the network device, including detailed data to be processed and any special conditions associated with the task. For example, the UE may indicate that the data involves sensitive personal information, and the UE may indicate that processing of such data is to be in accordance with one or more privacy conditions or privacy policies. In some aspects, the UE may send the additional information associated with the compute request in response to the network device requesting such additional information.

As shown in FIG. 7C, and reference number 735, a UE may send, and the network device may receive, a compute request that requests additional computing resources from a serving device for performing a computational task, as described herein.

As shown by reference number 740, the network device may send, and an NWCSF may receive, a message including information associated with the compute request. For example, the network node may relay the compute request and any associated information to the NWCSF. In some aspects, relaying the compute request may include the network node forwarding the compute request and associated information to the NWCSF for processing. Additionally, or alternatively, the network node may act as an intermediary, relaying the UE's compute request to the NWCSF.

As shown by reference number 745, the NWCSF may send, and the network device may receive, a response including information associated with the compute request. For example, the response may indicate the availability of computing resources and any conditions or constraints. For example, the NWCSF may inform the network node of the current availability of resources and any specific instructions for their use.

As shown by reference number 750, the network node may send, and the UE may receive, a response indicating the availability of additional computing resources. For example, the network node may forward the response from the NWCSF to the UE, indicating whether the requested resources are available. For example, the network node may pass along the NWCSF's confirmation that the resources are partially available with certain limitations. Additionally, for example, the network node may inform the UE that some resources are currently in use and suggest alternative times for access.

Additionally, or alternatively, the UE may send the compute request directly to the NWCSF. In some aspects, sending the compute request directly to the NWCSF may include the UE bypassing the network device and sending the compute request directly to the NWCSF according to one or more NWCSF configurations. Additionally, or alternatively, the NWCSF may be co-located with the network device. In some aspects the NWCSF configurations may be obtained by the UE from a network device, from the NWCSF, or according to a wireless communication standard, among other examples. In some aspects, the UE may send the compute request directly to the NWCSF in order to expedite the processing of a time-sensitive computational task. In some aspects, the UE sending the compute request directly to the NWCSF according to one or more NWCSF configurations may operate in a similar manner to the UE requesting information according to one or more alternative configurations.

In some aspects, the NWCSF configuration may be associated with communication over a control plane or over a user plane. Additionally, the data sent according to the NWCSF configuration may be included in NAS messages that pass through one or more intermediate nodes (e.g., a network device, an AMF, or a network node, among other examples) and that the intermediate nodes may be unable to read. Additionally, or alternatively, the intermediate nodes may be able to read the data based on the intermediate nodes satisfying one or more authorization conditions.

In some aspects, the NWCSF may coordinate with additional compute nodes (e.g., serving devices) to schedule computing resources associated with the computational tasks related to the compute request. The NWCSF may then respond to the compute request regarding the availability of the computing resources. In some aspects, the response from the NWCSF related to the availability of computing resources may indicate a “denial” status (e.g., additional computing resources are unavailable), a “pending” status (e.g., awaiting computing resource availability), an “accepted for future” status (e.g., computational tasks will begin at a later time), an “accepted and running” status (e.g., the compute request has been accepted and the computational tasks are running), or a “conditional acceptance” status (e.g., including additional restrictions, where the NWCSF may query the UE regarding whether the UE accepts the additional restrictions), among other examples. In some aspects, the acceptance status may include a combination of statuses (e.g., different statuses may be indicated for different sub-tasks associated with the compute request, including a request for confirmation of one or more of the sub-tasks).

In some aspects, where the UE communicates with the NWCSF, such communications may be via RRC messages (e.g., within NAS containers), which may go through a network device (e.g., a network node). In such a scenario, lower layer or lower latency signaling (e.g., MAC-CE messages in L2 or UCI messages in L1) from the UE to the network device may be precluded. Similarly, lower layer or lower latency signaling (e.g., MAC-CE messages in L2 or DCI messages in L1), from the network device to the UE, and related to positive acknowledgement or negative acknowledgement of the compute request, may be precluded.

Additionally, or alternatively, in some aspects, communications between the UE and the network device (e.g., associated with the compute request) may occur via L1 or L2 signaling. Where the NWCSF is co-located with the network device, such L1 or L2 signaling may suffice for communications between the UE and the NWCSF. However, where the NWCSF is located at a different node (e.g., a network node different than the network node serving the UE), the network device (e.g., a network node) may act as a relay between the UE and the NWCSF.

In some aspects, the network device's relaying of communications between the UE and the NWCSF may be accomplished via an associated relay configuration. In some aspects, because L1 or L2 signaling may be decided by a DU rather than a CU, any messages between the UE and the NWCSF may also be relayed between the DU and the CU (e.g., similarly to an F1 application protocol (AP) communication configuration). Additionally, or alternatively, the relay configuration may terminate at the DU instead of the CU (e.g., the communication may be dissimilar to the F1 AP communication configuration).

In some aspects, in the context of positioning, the network device may be involved in sending DL positioning reference signals (PRSs) and receiving UL PRSs. For computational tasks, the network device may be associated with one or more aspects of participation. For example, the network device may be ignorant of computational tasks or computing resources, and the network device may serve only as a relay for messages between the UE and the NWCSF. Additionally, or alternatively, the network device may lack computing resources, but the network device may be aware of other network devices (e.g., compute nodes) that have computing resources. Accordingly, the network device may coordinate with the other network devices (e.g., compute nodes) and with the NWCSF to fulfill the compute request. Additionally, or alternatively, the network device may have computing resources but may be unaware of other network devices (e.g., compute nodes), and the network device may report its resource availability to the NWCSF and may rely on the NWCSF coordination for running the compute requests on the network device. The NWCSF may also delegate authority to run one or more computational tasks directly to the network device's computing resources (e.g., the network device may behave similarly to where the network device is co-located with an NWCSF). Additionally, or alternatively, the network device may have computing resources and may be aware of other network devices (e.g., compute nodes) that have resources, and the network device may coordinate resources between the network device and the other network devices for running computational tasks associated with the compute request.

Additionally, or alternatively, the NWCSF may be an over-the-top (OTT) server, may be included in an OTT server, or may be associated with an OTT server, among other examples. In some aspects, the OTT server may be developed and deployed independently of one or more wireless communication standards. For example, the OTT server may be hosted on various platforms, including cloud services, edge computing nodes, or dedicated data centers, among other examples. In some aspects, the UE may interact with the OTT server via a dedicated application, utilizing a manual graphical user interface (GUI) or other interface, or via an automated interface (e.g., an API) that may be called by other applications associated with the UE.

As shown by FIG. 7D, and reference number 760, a client UE may send, and a network device may receive, a compute request that requests additional computing resources from a serving device for performing a computational task, as described herein. For example, the network device may be in communication with one or more service devices (e.g., serving UEs, serving computers, or other serving devices within a local mesh network or via Wi-Fi).

As shown by reference number 765, the network device may identify one or more serving devices having computing resources suitable for the compute request. For example, the identified serving devices may satisfy one or more conditions associated with the compute request, including processing or battery resource availability, time or latency conditions, computing service type conditions, or security conditions, among other examples described herein. In some aspects, the serving devices may register and periodically update their available computational resources to the network device. For example, during registration, a serving device may indicate the types and quantities of computational resources that it can offer for distributed computing tasks. This information may include processing power, memory capacity, and other relevant metrics. Additionally, serving devices may periodically update the network regarding any changes in their available resources, ensuring that the network has current information for efficiently allocating computational tasks

As shown by reference number 770, the network device may send, and the UE may receive, a response to the compute request indicating an availability of the additional computing resources. For example, the network device may indicate that one or more serving devices may have availability for performing a computational task, as described herein.

As described herein and according to some examples, the described techniques may enable a UE to utilize idle computing resources from other devices, by enabling communications between the UE and a network device concerning the UE's request for additional computing resources. Some aspects more specifically relate to a UE sending a compute request to a network device, requesting additional computing resources from a serving device for performing a computational task, and subsequently receiving a response from the network device indicating the availability of the additional computing resources. In some aspects, the UE may send detailed information about the computational task, including the type of computational task, the computing type associated with the task, or any security conditions associated with the computational task. The UE may also indicate specific time periods within which the network device is to accept or reject the compute request. Additionally, in some aspects, before sending the compute request, the UE may send one or more sets of information associated with computational tasks to the network device, and the compute request may then indicate a set of information that is relevant to the current task. Additionally, in some aspects, the compute request may be sent directly to an NWCSF, or the network device may send a message to the NWCSF, including information associated with the compute request.

As a result, in some examples, the described techniques can be used to request computing resources in a flexible and dynamic manner, thereby improving efficiency of network resource utilization by distributing computational loads across devices with available computational capacity. This distribution of computational loads may conserve processing resources and reduce demand on UE resources (e.g., on-device processing and power usage) and on network resources (e.g., MEC applications or the like), which can result in decreased network traffic and reduced latency for resource-intensive tasks. Additionally, where the UE sends, to the network node before sending the compute request, one or more sets of information associated with computational tasks to the network device, the UE may reduce the transmission overhead associated with each compute request. Additionally, by sending the compute request or information associated with the compute request to an NWCSF, the network may centralize the management of computing resources, allowing for optimized allocation based on current network conditions and the conditions associated with the computational tasks. This adaptability may enable the UE to conserve energy by entering a low-power state when appropriate, or to expedite resource allocation for time-sensitive tasks, thereby conserving battery resources and improving the overall efficiency of network communications.

As indicated above, FIGS. 7A-7D are provided as examples. Other examples may differ from what is described with respect to FIGS. 7A-7D.

FIG. 8 is a diagram illustrating an example process 800 performed, for example, at a UE or an apparatus of a UE. Example process 800 is an example where the apparatus or the UE (e.g., UE 120) performs operations associated with requests for computational resource allocation.

As shown in FIG. 8, in some aspects, process 800 may include sending, to a network device, a compute request that requests additional computing resources from a serving device for performing a computational task (block 810). For example, the UE (e.g., using communication manager 1006, depicted in FIG. 10) may send, to a network device, a compute request that requests additional computing resources from a serving device for performing a computational task, as described above.

As further shown in FIG. 8, in some aspects, process 800 may include receiving, from the network device, a response to the compute request indicating an availability of the additional computing resources (block 820). For example, the UE (e.g., using reception component 1002 or communication manager 1006, depicted in FIG. 10) may receive, from the network device, a response to the compute request indicating an availability of the additional computing resources, as described above.

Process 800 may include additional aspects, such as any single aspect or any combination of aspects described below or in connection with one or more other processes described elsewhere herein.

In a first aspect, the computational task is associated with an artificial intelligence or machine learning process.

In a second aspect, alone or in combination with the first aspect, the additional computing resources include at least one of processing resources or memory resources.

In a third aspect, alone or in combination with one or more of the first and second aspects, the compute request includes information associated with a computational task type.

In a fourth aspect, alone or in combination with one or more of the first through third aspects, the compute request includes information associated with a computing type associated with the computational task.

In a fifth aspect, alone or in combination with one or more of the first through fourth aspects, the compute request includes information associated with one or more security conditions associated with the computational task.

In a sixth aspect, alone or in combination with one or more of the first through fifth aspects, process 800 includes sending, to the network device prior to sending the compute request, one or more sets of information associated one or more computational tasks, and the compute request indicates a set of information, of the one or more sets of information, associated with the computational task.

In a seventh aspect, alone or in combination with one or more of the first through sixth aspects, the compute request includes a profile indicator associated with the UE.

In an eighth aspect, alone or in combination with one or more of the first through seventh aspects, the compute request includes context information associated with the UE.

In a ninth aspect, alone or in combination with one or more of the first through eighth aspects, the compute request is sent in a PRACH message based on the UE being in an RRC-IDLE or an RRC-INACTIVE state.

In a tenth aspect, alone or in combination with one or more of the first through ninth aspects, the response includes an acceptance of the compute request, sent as a message 4 in a contention-based RACH procedure or as a random access response message in a contention-free RACH procedure.

In an eleventh aspect, alone or in combination with one or more of the first through tenth aspects, the compute request is sent in an uplink control message based on the UE being in an RRC-CONNECTED state.

In a twelfth aspect, alone or in combination with one or more of the first through eleventh aspects, the compute request is sent in a scheduling request message or a detailed computation status report, based on the UE being in an RRC-CONNECTED state.

In a thirteenth aspect, alone or in combination with one or more of the first through twelfth aspects, process 800 includes sending, to the network device, a MAC-CE message that includes additional information associated with the compute request.

In a fourteenth aspect, alone or in combination with one or more of the first through thirteenth aspects, the additional information may include an indication of data size associated with the computational task.

In a fifteenth aspect, alone or in combination with one or more of the first through fourteenth aspects, the compute request is sent in an RRC message based on the UE being in an RRC-CONNECTED state.

In a sixteenth aspect, alone or in combination with one or more of the first through fifteenth aspects, process 800 includes transitioning to a low-power state after sending the compute request.

In a seventeenth aspect, alone or in combination with one or more of the first through sixteenth aspects, the compute request indicates a time period within which the network device is to accept or reject the compute request.

In an eighteenth aspect, alone or in combination with one or more of the first through seventeenth aspects, the time period is associated with one or more latency conditions.

In a nineteenth aspect, alone or in combination with one or more of the first through eighteenth aspects, process 800 includes sending, to the network device, additional information associated with the computational task, via an uplink transmission.

In a twentieth aspect, alone or in combination with one or more of the first through nineteenth aspects, the response includes an acceptance or a denial of the compute request.

In a twenty-first aspect, alone or in combination with one or more of the first through twentieth aspects, the response is included in a downlink control signal.

In a twenty-second aspect, alone or in combination with one or more of the first through twenty-first aspects, the response is received via a paging message when the UE is in a low-power state.

In a twenty-third aspect, alone or in combination with one or more of the first through twenty-second aspects, the compute request includes a request for an RRC connection and an uplink resource grant, for the UE to send data related to the computational task.

In a twenty-fourth aspect, alone or in combination with one or more of the first through twenty-third aspects, the response includes an uplink resource grant for the UE to send data related to the computational task.

In a twenty-fifth aspect, alone or in combination with one or more of the first through twenty-fourth aspects, process 800 includes sending data using the uplink resource grant.

In a twenty-sixth aspect, alone or in combination with one or more of the first through twenty-fifth aspects, the compute request is sent directly to an NWCSF.

In a twenty-seventh aspect, alone or in combination with one or more of the first through twenty-sixth aspects, the response includes an acceptance, a pending status, or a denial of the compute request.

In a twenty-eighth aspect, alone or in combination with one or more of the first through twenty-seventh aspects, the network device is co-located with the NWCSF.

In a twenty-ninth aspect, alone or in combination with one or more of the first through twenty-eighth aspects, the NWCSF is an OTT server.

In a thirtieth aspect, alone or in combination with one or more of the first through twenty-ninth aspects, the UE interacts with the OTT server via a dedicated application associated with the UE.

In a thirty-first aspect, alone or in combination with one or more of the first through thirtieth aspects, the additional computing resources are external to the UE and are not currently allocated to the UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network device or an apparatus of a network device. Example process 900 is an example where the apparatus or the network device (e.g., network node 110) performs operations associated with requests for computational resource allocation.

As shown in FIG. 9, in some aspects, process 900 may include receiving, from a UE, a compute request that requests additional computing resources from a serving device for performing a computational task (block 910). For example, the network device (e.g., using reception component 1102 or communication manager 1106, depicted in FIG. 11) may receive, from a UE, a compute request that requests additional computing resources from a serving device for performing a computational task, as described above.

As further shown in FIG. 9, in some aspects, process 900 may include sending, to the UE, a response to the compute request indicating an availability of the additional computing resources (block 920). For example, the network device (e.g., using communication manager 1106, depicted in FIG. 11) may send, to the UE, a response to the compute request indicating an availability of the additional computing resources, as described above.

Process 900 may include additional aspects, such as any single aspect or any combination of aspects described below or in connection with one or more other processes described elsewhere herein.

In a first aspect, the computational task is associated with an artificial intelligence or machine learning process.

In a second aspect, alone or in combination with the first aspect, the additional computing resources include at least one of processing resources or memory resources.

In a third aspect, alone or in combination with one or more of the first and second aspects, the compute request includes information associated with a computational task type.

In a fourth aspect, alone or in combination with one or more of the first through third aspects, the compute request includes information associated with a computing type associated with the computational task.

In a fifth aspect, alone or in combination with one or more of the first through fourth aspects, the compute request includes information associated with one or more security conditions associated with the computational task.

In a sixth aspect, alone or in combination with one or more of the first through fifth aspects, process 900 includes receiving, from the UE prior to receiving the compute request, one or more sets of information associated one or more computational tasks, and the compute request indicates a set of information, of the one or more sets of information, associated with the computational task.

In a seventh aspect, alone or in combination with one or more of the first through sixth aspects, the compute request includes a profile indicator associated with the UE.

In an eighth aspect, alone or in combination with one or more of the first through seventh aspects, the compute request includes context information associated with the UE.

In a ninth aspect, alone or in combination with one or more of the first through eighth aspects, the compute request is received in a PRACH message.

In a tenth aspect, alone or in combination with one or more of the first through ninth aspects, the response includes an acceptance of the compute request, sent as a message 4 in a contention-based RACH procedure or as a random access response message in a contention-free RACH procedure.

In an eleventh aspect, alone or in combination with one or more of the first through tenth aspects, the compute request is received in an uplink control message.

In a twelfth aspect, alone or in combination with one or more of the first through eleventh aspects, the compute request is received in a scheduling request message or a detailed computation status report.

In a thirteenth aspect, alone or in combination with one or more of the first through twelfth aspects, process 900 includes receiving, from the UE, a MAC-CE message that includes additional information associated with the compute request.

In a fourteenth aspect, alone or in combination with one or more of the first through thirteenth aspects, the additional information may include an indication of data size associated with the computational task.

In a fifteenth aspect, alone or in combination with one or more of the first through fourteenth aspects, the compute request is received in an RRC message.

In a sixteenth aspect, alone or in combination with one or more of the first through fifteenth aspects, the compute request indicates a time period within which the network device is to accept or reject the compute request.

In a seventeenth aspect, alone or in combination with one or more of the first through sixteenth aspects, the time period is associated with one or more latency conditions.

In an eighteenth aspect, alone or in combination with one or more of the first through seventeenth aspects, process 900 includes receiving, from the UE, additional information associated with the computational task, via an uplink transmission.

In a nineteenth aspect, alone or in combination with one or more of the first through eighteenth aspects, the response includes an acceptance or a denial of the compute request.

In a twentieth aspect, alone or in combination with one or more of the first through nineteenth aspects, the response is included in a downlink control signal.

In a twenty-first aspect, alone or in combination with one or more of the first through twentieth aspects, the response is included in a paging message.

In a twenty-second aspect, alone or in combination with one or more of the first through twenty-first aspects, the compute request includes a request for an RRC connection and an uplink resource grant, for the UE to send data related to the computational task.

In a twenty-third aspect, alone or in combination with one or more of the first through twenty-second aspects, the response includes an uplink resource grant for the UE to send data related to the computational task.

In a twenty-fourth aspect, alone or in combination with one or more of the first through twenty-third aspects, process 900 includes receiving data via the uplink resource grant.

In a twenty-fifth aspect, alone or in combination with one or more of the first through twenty-fourth aspects, the compute request is sent directly to an NWCSF associated with the network device.

In a twenty-sixth aspect, alone or in combination with one or more of the first through twenty-fifth aspects, the response includes an acceptance, a pending status, or a denial of the compute request.

In a twenty-seventh aspect, alone or in combination with one or more of the first through twenty-sixth aspects, the network device is co-located with the NWCSF.

In a twenty-eighth aspect, alone or in combination with one or more of the first through twenty-seventh aspects, the NWCSF is an OTT server.

In a twenty-ninth aspect, alone or in combination with one or more of the first through twenty-eighth aspects, the UE interacts with the OTT server via a dedicated application associated with the UE.

In a thirtieth aspect, alone or in combination with one or more of the first through twenty-ninth aspects, process 900 includes sending, to an NWCSF, a message including information associated with the compute request, and receiving, from the NWCSF, an NWCSF response including information associated with the compute request, and the response includes the information associated with the compute request.

In a thirty-first aspect, alone or in combination with one or more of the first through thirtieth aspects, the additional computing resources are external to the UE and are not currently allocated to the UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 7A-7D Additionally, or alternatively, the apparatus 1000 may be configured to perform one or more processes described herein, such as process 800 of FIG. 8. In some aspects, the apparatus 1000 or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The communication manager 1006 may send, to a network device, a compute request that requests additional computing resources from a serving device for performing a computational task. The reception component 1002 may receive, from the network device, a response to the compute request indicating an availability of the additional computing resources.

The communication manager 1006 may send, to the network device prior to sending the compute request, one or more sets of information associated one or more computational tasks, and the compute request indicates a set of information, of the one or more sets of information, associated with the computational task.

The transmission component 1004 may send, to the network device, a MAC-CE message that includes additional information associated with the compute request.

The communication manager 1006 may transition to a low-power state after sending the compute request.

The transmission component 1004 may send, to the network device, additional information associated with the computational task, via an uplink transmission.

The transmission component 1004 may send data using the uplink resource grant.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network device, or a network device may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the network device.

In some aspects, the apparatus 1100 may be configured to perform one or more operations described herein in connection with FIGS. 7A-7D. Additionally, or alternatively, the apparatus 1100 may be configured to perform one or more processes described herein, such as process 900 of FIG. 9. In some aspects, the apparatus 1100 or one or more components shown in FIG. 11 may include one or more components of the network device described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network device described above in connection with FIG. 1, such as a radio, one or more RF chains, one or more transceivers, or one or more modems, each of which may in turn be coupled with one or more antennas of the network device.

The transmission component 1104 may send communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network device described above in connection with FIG. 1, such as a radio, one or more RF chains, one or more transceivers, or one or more modems, each of which may in turn be coupled with one or more antennas of the network device described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 may receive, from a UE, a compute request that requests additional computing resources from a serving device for performing a computational task. The communication manager 1106 may send, to the UE, a response to the compute request indicating an availability of the additional computing resources.

The reception component 1102 may receive, from the UE prior to receiving the compute request, one or more sets of information associated one or more computational tasks, and the compute request indicates a set of information, of the one or more sets of information, associated with the computational task.

The reception component 1102 may receive, from the UE, a MAC-CE message that includes additional information associated with the compute request.

The reception component 1102 may receive, from the UE, additional information associated with the computational task, via an uplink transmission.

The reception component 1102 may receive data via the uplink resource grant.

The communication manager 1106 may send, to an NWCSF, a message including information associated with the compute request.

The reception component 1102 may receive, from the NWCSF, an NWCSF response including information associated with the compute request, and the response includes the information associated with the compute request.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: sending, to a network device, a compute request that requests additional computing resources from a serving device for performing a computational task; and receiving, from the network device, a response to the compute request indicating an availability of the additional computing resources.

Aspect 2: The method of Aspect 1, wherein the computational task is associated with an artificial intelligence or machine learning process.

Aspect 3: The method of any of Aspects 1-2, wherein the additional computing resources include at least one of processing resources or memory resources.

Aspect 4: The method of any of Aspects 1-3, wherein the compute request includes information associated with a computational task type.

Aspect 5: The method of any of Aspects 1-4, wherein the compute request includes information associated with a computing type associated with the computational task.

Aspect 6: The method of any of Aspects 1-5, wherein the compute request includes information associated with one or more security conditions associated with the computational task.

Aspect 7: The method of any of Aspects 1-6, further comprising: sending, to the network device prior to sending the compute request, one or more sets of information associated one or more computational tasks, wherein the compute request indicates a set of information, of the one or more sets of information, associated with the computational task.

Aspect 8: The method of any of Aspects 1-7, wherein the compute request includes a profile indicator associated with the UE.

Aspect 9: The method of any of Aspects 1-8, wherein the compute request includes context information associated with the UE.

Aspect 10: The method of any of Aspects 1-9, wherein the compute request is sent in a physical random access channel (PRACH) message based on the UE being in a radio resource control (RRC)-IDLE or an RRC-INACTIVE state.

Aspect 11: The method of Aspect 10, wherein the response includes an acceptance of the compute request, sent as a message 4 in a contention-based random access channel (RACH) procedure or as a random access response message in a contention-free RACH procedure.

Aspect 12: The method of any of Aspects 1-11, wherein the compute request is sent in an uplink control message based on the UE being in a radio resource control (RRC)-CONNECTED state.

Aspect 13: The method of any of Aspects 1-12, wherein the compute request is sent in a scheduling request message or a detailed computation status report, based on the UE being in a radio resource control (RRC)-CONNECTED state.

Aspect 14: The method of Aspect 13, further comprising: sending, to the network device, a medium access control control element (MAC-CE) message that includes additional information associated with the compute request.

Aspect 15: The method of Aspect 14, wherein the additional information may include an indication of data size associated with the computational task.

Aspect 16: The method of any of Aspects 1-15, wherein the compute request is sent in an RRC message based on the UE being in a radio resource control (RRC)-CONNECTED state.

Aspect 17: The method of any of Aspects 1-16, further comprising: transitioning to a low-power state after sending the compute request.

Aspect 18: The method of any of Aspects 1-17, wherein the compute request indicates a time period within which the network device is to accept or reject the compute request.

Aspect 19: The method of Aspect 18, wherein the time period is associated with one or more latency conditions.

Aspect 20: The method of any of Aspects 1-19, further comprising: sending, to the network device, additional information associated with the computational task, via an uplink transmission.

Aspect 21: The method of any of Aspects 1-20, wherein the response includes an acceptance or a denial of the compute request.

Aspect 22: The method of Aspect 21, wherein the response is included in a downlink control signal.

Aspect 23: The method of any of Aspects 1-22, wherein the response is received via a paging message when the UE is in a low-power state.

Aspect 24: The method of any of Aspects 1-23, wherein the compute request includes a request for a radio resource control (RRC) connection and an uplink resource grant, for the UE to send data related to the computational task.

Aspect 25: The method of any of Aspects 1-24, wherein the response includes an uplink resource grant for the UE to send data related to the computational task.

Aspect 26: The method of Aspect 25, further comprising: sending data using the uplink resource grant.

Aspect 27: The method of any of Aspects 1-26, wherein the compute request is sent directly to a network computing service function (NWCSF).

Aspect 28: The method of Aspect 27, wherein the response includes an acceptance, a pending status, or a denial of the compute request.

Aspect 29: The method of Aspect 27, wherein the network device is co-located with the NWCSF.

Aspect 30: The method of Aspect 27, wherein the NWCSF is an over-the-top (OTT) server.

Aspect 31: The method of Aspect 30, wherein the UE interacts with the OTT server via a dedicated application associated with the UE.

Aspect 32: The method of any of Aspects 1-31, wherein the additional computing resources are external to the UE and are not currently allocated to the UE.

Aspect 33: A method of wireless communication performed by a network device, comprising: receiving, from a user equipment (UE), a compute request that requests additional computing resources from a serving device for performing a computational task; and sending, to the UE, a response to the compute request indicating an availability of the additional computing resources.

Aspect 34: The method of Aspect 33, wherein the computational task is associated with an artificial intelligence or machine learning process.

Aspect 35: The method of any of Aspects 33-34, wherein the additional computing resources include at least one of processing resources or memory resources.

Aspect 36: The method of any of Aspects 33-35, wherein the compute request includes information associated with a computational task type.

Aspect 37: The method of any of Aspects 33-36, wherein the compute request includes information associated with a computing type associated with the computational task.

Aspect 38: The method of any of Aspects 33-37, wherein the compute request includes information associated with one or more security conditions associated with the computational task.

Aspect 39: The method of any of Aspects 33-38, further comprising: receiving, from the UE prior to receiving the compute request, one or more sets of information associated one or more computational tasks, wherein the compute request indicates a set of information, of the one or more sets of information, associated with the computational task.

Aspect 40: The method of any of Aspects 33-39, wherein the compute request includes a profile indicator associated with the UE.

Aspect 41: The method of any of Aspects 33-40, wherein the compute request includes context information associated with the UE.

Aspect 42: The method of any of Aspects 33-41, wherein the compute request is received in a physical random access channel (PRACH) message.

Aspect 43: The method of Aspect 42, wherein the response includes an acceptance of the compute request, sent as a message 4 in a contention-based random access channel (RACH) procedure or as a random access response message in a contention-free RACH procedure.

Aspect 44: The method of any of Aspects 33-43, wherein the compute request is received in an uplink control message.

Aspect 45: The method of any of Aspects 33-44, wherein the compute request is received in a scheduling request message or a detailed computation status report.

Aspect 46: The method of Aspect 45, further comprising: receiving, from the UE, a medium access control control element (MAC-CE) message that includes additional information associated with the compute request.

Aspect 47: The method of Aspect 46, wherein the additional information may include an indication of data size associated with the computational task.

Aspect 48: The method of any of Aspects 33-47, wherein the compute request is received in an RRC message.

Aspect 49: The method of any of Aspects 33-48, wherein the compute request indicates a time period within which the network device is to accept or reject the compute request.

Aspect 50: The method of Aspect 49, wherein the time period is associated with one or more latency conditions.

Aspect 51: The method of any of Aspects 33-50, further comprising: receiving, from the UE, additional information associated with the computational task, via an uplink transmission.

Aspect 52: The method of any of Aspects 33-51, wherein the response includes an acceptance or a denial of the compute request.

Aspect 53: The method of Aspect 52, wherein the response is included in a downlink control signal.

Aspect 54: The method of any of Aspects 33-53, wherein the response is included in a paging message.

Aspect 55: The method of any of Aspects 33-54, wherein the compute request includes a request for a radio resource control (RRC) connection and an uplink resource grant, for the UE to send data related to the computational task.

Aspect 56: The method of any of Aspects 33-55, wherein the response includes an uplink resource grant for the UE to send data related to the computational task.

Aspect 57: The method of Aspect 56, further comprising: receiving data via the uplink resource grant.

Aspect 58: The method of any of Aspects 33-57, wherein the compute request is sent directly to a network computing service function (NWCSF) associated with the network device.

Aspect 59: The method of Aspect 58, wherein the response includes an acceptance, a pending status, or a denial of the compute request.

Aspect 60: The method of Aspect 58, wherein the network device is co-located with the NWCSF.

Aspect 61: The method of Aspect 58, wherein the NWCSF is an over-the-top (OTT) server.

Aspect 62: The method of Aspect 61, wherein the UE interacts with the OTT server via a dedicated application associated with the UE.

Aspect 63: The method of any of Aspects 33-62, further comprising: sending, to a network computing service function (NWCSF), a message including information associated with the compute request; and receiving, from the NWCSF, an NWCSF response including information associated with the compute request, wherein the response includes the information associated with the compute request.

Aspect 64: The method of any of Aspects 33-63, wherein the additional computing resources are external to the UE and are not currently allocated to the UE.

Aspect 65: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-64.

Aspect 66: An apparatus for wireless communication at a device, the apparatus comprising one or more memories and one or more processors coupled to the one or more memories, the one or more processors configured to cause the device to perform the method of one or more of Aspects 1-64.

Aspect 67: An apparatus for wireless communication, the apparatus comprising at least one means for performing the method of one or more of Aspects 1-64.

Aspect 68: A non-transitory computer-readable medium storing code for wireless communication, the code comprising instructions executable by one or more processors to perform the method of one or more of Aspects 1-64.

Aspect 69: A non-transitory computer-readable medium storing a set of instructions for wireless communication, the set of instructions comprising one or more instructions that, when executed by one or more processors of a device, cause the device to perform the method of one or more of Aspects 1-64.

Aspect 70: A device for wireless communication, the device comprising a processing system that includes one or more processors and one or more memories coupled with the one or more processors, the processing system configured to cause the device to perform the method of one or more of Aspects 1-64.

Aspect 71: An apparatus for wireless communication at a device, the apparatus comprising one or more memories and one or more processors coupled to the one or more memories, the one or more processors individually or collectively configured to cause the device to perform the method of one or more of Aspects 1-64.

Aspect 72: A device comprising a processing system that includes one or more processors and one or more code-storing memories coupled with the one or more processors, the processing system configured to cause the device to perform the method of one or more of Aspects 1-64.

Aspect 73: A device comprising a processing system that includes processor circuitry and code-storing memory circuitry, the processing system configured to cause the device to perform the method of one or more of Aspects 1-64.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
send, to a network device, a compute request that requests additional computing resources from a serving device for performing a computational task; and
receive, from the network device, a response to the compute request indicating an availability of the additional computing resources.

2. The UE of claim 1, wherein the additional computing resources are external to the UE and are not currently allocated to the UE.

3. The UE of claim 1, wherein the compute request includes information associated with a computational task type.

4. The UE of claim 1, wherein the compute request includes information associated with a computing type associated with the computational task.

5. The UE of claim 1, wherein the compute request includes information associated with one or more security conditions associated with the computational task.

6. The UE of claim 1, wherein the processing system is configured to cause the UE to:
send, to the network device prior to sending the compute request, one or more sets of information associated one or more computational tasks, wherein the compute request indicates a set of information, of the one or more sets of information, associated with the computational task.

7. The UE of claim 1, wherein the compute request is sent in a physical random access channel (PRACH) message based on the UE being in a radio resource control (RRC)-IDLE or an RRC-INACTIVE state.

8. The UE of claim 1, wherein the compute request is sent in an uplink control message based on the UE being in a radio resource control (RRC)-CONNECTED state.

9. The UE of claim 1, wherein the compute request is sent in a scheduling request message or a detailed computation status report, based on the UE being in a radio resource control (RRC)-CONNECTED state.

10. The UE of claim 1, wherein the processing system is configured to cause the UE to:
transition to a low-power state after sending the compute request.

11. The UE of claim 1, wherein the compute request indicates a time period within which the network device is to accept or reject the compute request.

12. The UE of claim 1, wherein the processing system is configured to cause the UE to:
send, to the network device, additional information associated with the computational task, via an uplink transmission.

13. The UE of claim 1, wherein the response includes an acceptance or a denial of the compute request.

14. The UE of claim 1, wherein the compute request includes a request for a radio resource control (RRC) connection and an uplink resource grant, for the UE to send data related to the computational task.

15. The UE of claim 1, wherein the response includes an uplink resource grant for the UE to send data related to the computational task.

16. A network device, comprising:
a processing system that includes one or more processors and one or more code-storing memories coupled with the one or more processors, the processing system configured to cause the network device to:
receive, from a user equipment (UE), a compute request that requests additional computing resources from a serving device for performing a computational task; and
send, to the UE, a response to the compute request indicating an availability of the additional computing resources.

17. The network device of claim 15, wherein the compute request is received in a radio resource control (RRC) message.

18. The network device of claim 15, wherein the compute request indicates a time period within which the network device is to accept or reject the compute request.

19. The network device of claim 15, wherein the processing system is configured to cause the network device to:
receive, from the UE, additional information associated with the computational task, via an uplink transmission.

20. A method of wireless communication performed by a user equipment (UE), comprising:
sending, to a network device, a compute request that requests additional computing resources from a serving device for performing a computational task; and
receiving, from the network device, a response to the compute request indicating an availability of the additional computing resources.
